(19) United States
(12) Patent Application Publication
(10) Pub. No.: US 2009/0130330 A1
(43) Pub. Date: May 21, 2009

(54) Method for producing Functional Fluorocarbon Polymer Layers by Means of Plasma Polymerization of Perfluorocycloalkanes

(75) Inventors: Michael Haupt, Boblingen (DE); Jakob Barz, Stuttgart (DE); Christian Oehr, Herrenberg (DE)

Correspondence Address: DARBY & DARBY P.C., P.O. BOX 770, Church Street Station, New York, NY, 10008-0770, US

(73) Assignee: Fraunhofer-Gesellschaft zur Foerderung der angerwandten Forschung e.V., Muenchen (DE)

(21) Appl. No.: 11/995,479

(22) PCT Filed: Jul. 26, 2006
(86) PCT No.: PCT/EP2006/007359

§ 371 Date: Jan. 11, 2008

(30) Foreign Application Priority Data
Jul. 26, 2005 (DE) 10 2005 034 764.9

(51) Int. Cl. B05D 3/06

(52) U.S. Cl. 427/534; 427/569; 427/535

(57) ABSTRACT

The present invention relates to a method for producing fluorocarbon layers on a substrate, e.g., a metal, polymer, ceramic material and/or textiles by means of a low-pressure plasma method and products produced in this way.

This application is a U.S. national phase application under 35 U.S.C. §371 of International Patent Application No. PCT/EP2006/007359 filed Jul. 26, 2006, which claims the benefit of priority to German Patent Application No. DE 10 2005 034 764.9 filed Jul. 26, 2005, the disclosures of all of which are hereby incorporated by reference in their entireties. The International Application was published in German on Feb. 1, 2007 as WO 2007/012472.

The present invention relates to a method for producing fluorocarbon layers on a substrate, e.g., a metal, polymer and/or textile by means of a low-pressure plasma method as well as the products produced in this way. The fluorocarbon layers are preferably produced at least partially as gradient layers on the substrate. Coating methods, i.e., finishing methods for applying adhering layers of shapeless, formless, substances to substrates, workpieces or carrier sheeting are known. These coating methods include coating methods in which a coating on a substrate can be produced from a gaseous or vapor state. The latter coating methods also include plasma coating methods. Such methods make use of chemical reactions that take place in a plasma, in particular plasma polymerization methods, where the term “plasma” is understood to refer to a gas that is electrically neutral toward the outside and which contains neutral particles, free radicals, ions and electrons energized electronically by different types of excitation that are deposited in the form of chemical substances, especially polymers, on a substrate that is exposed to the plasma. Known plasma methods, however, could be improved on the one hand with regard to adhesion of the layer applied by the plasmatic reactions, in particular also plasma polymerization, to the substrate. They are also capable of improvement with regard to their total surface energy, which should be as low as possible for many applications. It is also desirable to provide a coating whose adhesion with respect to other materials is as low as possible and thus ensures antistick properties. Known coatings are also frequently characterized by the fact that they have sliding and adhesive friction properties that can be improved. It is desirable to provide an improved sliding and adhesive friction, i.e., a lower friction due to friction-reduced properties of the surface. Finally, it is desirable to design the plasma coating so that the substrates are protected from external influences such as chemical attack, e.g., due to acids and bases or abrasive stresses.

Therefore, the technical problem on which the present invention is based is to provide coating methods and coatings that achieve the aforementioned goals and overcome the disadvantages described here.

The present invention solves the technical problem on which it is based by providing a method for producing fluorocarbon layers on a substrate by means of a low-pressure plasma process, wherein a substrate is provided and a plasma is created by a high-frequency discharge between at least two electrodes from reactive gas containing cyclic fluorocarbon compounds, and then layers containing or comprising polymeric fluorocarbon compounds are deposited on and/or applied to the substrate. In a preferred embodiment, layers containing or comprising the polymeric fluorocarbon compounds are deposited on the substrate as gradient layers, e.g., they are applied as gradient layers. In another preferred embodiment, a portion, especially preferably a first portion of the layers containing or comprising the polymeric fluorocarbon compounds is deposited as gradient layers on the substrate, e.g., are applied as gradient layers. The present invention therefore provides a method by which a plasma polymerization process is used to apply fluorocarbon compounds to substrates which serve as a functional coating there and are deposited in the form of fluorocarbon polymers from a reactive gas which contains and/or consists of cyclic fluorocarbon compounds, especially perfluorocycloalkanes, as precursors (starting materials). In the perfluorocycloalkane plasma, the carbon ring of the perfluorocycloalkane is broken open. This creates a so-called biradical, which is highly crosslinked in the plasma polymerization process, especially at higher plasma power inputs, but also promotes the formation of long-chain fluorocarbons, in particular at lower plasma power inputs. As a result, in the case of higher plasma power inputs, a good layer stability, i.e., high degrees of crosslinking and good stability, can be achieved with respect to mechanical abrasive stresses, whereas at lower plasma power inputs, very low surface energies of less than 20 mN/m can be achieved.

The inventive method for producing functionalized layers, in particular fluorocarbon layers on substrates, especially metals, plastics, polymers, ceramics and textiles is characterized in particular by the fact that a very good adhesion of the layer applied by plasma polymerization to metals, plastics, polymers, ceramics and textiles is achieved. The inventive process functionalizes the surface of said substrates in such a way that low total surface energies, i.e., disperse plus polar components of surface energy down to less than 20 mN/m, and hydrophobization can be achieved. In addition, the inventive process makes it possible to provide especially advantageous antistick properties of the applied layers with respect to other materials, i.e., to reduce their adhesion. This invention advantageously allows a reduction in adhesion of rubber compounds, stainless steels or molten metal alloys such as solder to the applied plasma polymer layer.

The present invention also provides the advantage that the applied plasma coating protects the coated substrates from external influences such as chemical attack due to acids, bases or solvents or mechanical abrasive stresses. Finally, the invention is advantageously characterized in that the surface of the coated substrate has friction-reducing properties, i.e., both sliding friction and adhesive friction are reduced.

In an especially preferred embodiment, the present invention relates to a method for coating substrates, in which case especially metals, stainless steel, plastics, polymers, a ceramic material, textiles and/or composite materials of same are used as the substrate. The metals may preferably be alloys, especially aluminum alloys or stainless steel. The plastics or polymer may in particular be PET (polyethylene terephthalate), PC (polycarbonate), PP (polypropylene) or PMMA (polymethyl methacryate). The textiles may in particular be woven cotton cloth, PET or PP textiles. The substrates may be membranes in the preferred embodiment, especially porous membranes.

By means of the inventive plasma coating, the substrates to be coated, especially their surface, may be finished to be oliophobic as well as hydrophobic. In a preferred embodiment of the present invention, the inventive plasma coating is applied to polymers, metallic or ceramic membranes, especially porous membranes, especially to design the surface to be both oliophobic and hydrophobic. Wetting of the surface with solvents, e.g., fuels, is greatly reduced by the plasma coating, but the membrane remains permeable for the vapors. According to this invention, use of membranes plasma-coated according to the present invention is preferred for venting tank systems or tanks.

In another preferred embodiment, the present invention relates to a method of the aforementioned type using cyclic fluorocarbon compounds, which contain perfluorocycloalkanes, especially CₙF₂ₙ where n=3, 4 or 5. In another preferred embodiment, the perfluorocycloalkanes that are used are perfluorocyclopropane C₃F₆ (CAS 931-91-9), perfluorocyclobutane C₄F₈ (CAS 115-25-3) or perfluoro-cyclopentane C₅F₁₀ (CAS 376-77-2).

In another preferred embodiment, the invention proposes that the plasma be generated with a high-frequency discharge, especially at 13.56 MHz. According to this invention, the frequency range of the plasma discharge should also be 27.12 MHz or 2.45 GHz, especially 13.56 MHz.

In another preferred embodiment, an electrode mass that is used for generating a plasma is provided.

In another preferred embodiment, the substrate is either on the grounded electrode or on the electrode supplied with high frequency. In another preferred embodiment, the coating process, i.e., the application of the substances that are formed in the reactive gas to the substrate is performed in a pressure range from 0.03 mbar to 1 mbar.

In another preferred embodiment, the gas flows of the cyclic carbon compounds used to form the plasma, i.e., the precursors, in particular the perfluorocycloalkane precursors amount to 0.5 cm³/min per liter of reactor volume to 15 cm³/min per liter of reactor volume. The unit cm³/min corresponds to the unit sccm.

In another preferred embodiment, the power input for the high-frequency discharge amounts to 0.007 W/cm² to 0.2 W/cm², especially 0.1 W/cm² per unit of electrode area.

In another preferred embodiment, the coating process is continued for a period of up to 15 minutes, especially 1 to 15 minutes, preferably 10 to 15 minutes.

In another preferred embodiment, the layer thickness achieved in the applied polymer fluorocarbon layer is 50 to 300 nm, preferably 100 to 300 nm, especially 200 to 300 nm.

In another preferred embodiment, a so-called bias voltage, preferably an externally regulated, is applied to one of the two electrodes, preferably in a range from 0, preferably 1 to 100 V, especially during the coating process, and the degree of crosslinking and the layer adhesion can be improved even further in an advantageous manner.

In another preferred embodiment, a so-called bias voltage, preferably regulated externally, is applied to one of the two electrodes and is continuously varied, preferably in a range from 0, especially 1 to 100 V. The bias voltage is especially preferably increased continuously from 1 V to 100 V.

Through a continuous increase in the bias voltage, the degree of crosslinking of the fluorocarbon layers can be varied. In this way the strength of the adhesion and stresses in the fluorocarbon layers, especially preferably in the gradient layers on the substrate can be varied. With a higher bias voltage, the ion bombardment is intensified because the charged particles are accelerated toward the substrate to a greater extent. The fluorocarbon layers, especially preferably the gradient layers, are thereby crosslinked to a greater extent.

In another preferred embodiment, the substrate is optionally pretreated with a pretreatment plasma, e.g., a noble gas, especially argon or hydrogen or mixtures of a noble gas, especially argon, and hydrogen, optionally before the plasma coating, i.e., it is cleaned and the substrate surface is chemically activated, especially to create free binding sites. The surface is thereby activated chemically by the creation of free radical sites while also being slightly etched and crosslinked if necessary. The result is especially good adhesion of the polymeric fluorocarbon compounds to be applied to the substrate in an advantage manner.

The plasma pretreatment of the substrate that is preferred according to this invention takes place in an advantageous manner and in a preferred embodiment at total gas pressures of 0.03 to 2 mbar, preferably 0.03 to 1 mbar. In an especially preferred embodiment, the gas flows for the noble gas, especially argon and hydrogen are regulated separately; in a preferred manner, the gas flows amount to 2 cm³/min per liter of reactor volume each up to 35 cm³/min per liter of reactor volume. The power saving advantageously amounts to 0.07 to 0.3 watt/cm.

In a preferred manner, as part of the optional pretreatment, the power input is selected as a function of the substrate to be treated. Thus, in a preferred manner, a power density of up to 0.3 W/cm², especially 0.001 to 0.3 W/cm² is used for metals. In a preferred manner, a power density of up to 0.2 W/cm², especially 0.001 to 0.2 W/cm² is used when using plastic as a substrate.

In a preferred manner, the pretreatment of the substrate is performed for a period of up to 15 minutes, especially 1 to 15 minutes, preferably 10 to 15 minutes.

In an especially preferred embodiment according to the present invention, the desired layer of fluorocarbon compounds is applied directly after the substrate is provided, i.e., the desired functionalization is performed. As explained above, however, in another preferred embodiment, it is also possible to perform a pretreatment before applying the desired functionalization in the form of the applied polymeric fluorocarbon compounds.

In another preferred embodiment, it is possible to perform a two-step coating either without first performing a pretreatment or after performing a pretreatment, in which case in a first interval of time in the coating operation, a gradient layer is applied and in a second interval of time the desired functionalization is then applied.

In another preferred embodiment according to the present invention by targeted admixture of hydrogen to the reactive gas, i.e., the gas containing or comprising cyclic fluorocarbon compounds, the crosslinking and the fluorine content of the polymer layer can be controlled and the gradient layer thereby applied. This procedure first allows good adhesive of the layer to the substrate while secondly the surface energy of the layer can be adjusted.

Therefore, in a preferred manner, an optional gradient layer that improves the layer adhesive of the plasma polymer deposited on the substrate is applied to the substrate. This is accomplished by adding hydrogen in variable amount especially a variable gas flow to the plasma of perfluorocycloalkane, in which case the hydrogen gas flow is advantageously reduced during the addition in a preferred embodiment.

The fluorocarbon layer produced as a gradient layer surprisingly has the advantage that better adhesion to the substrate is achieved. Due to the adjustment of the degree of crosslinking by varying the hydrogen gas flow during the plasma process, which is made possible by the present invention in a preferred manner, the layer can be applied to harder surfaces especially metal, ceramics or semiconductors, as well as to softer surfaces, in particular polymers in an adjusted manner. In a preferred embodiment, the hydrogen flow rate can be regulated so that there is as little tension as possible at the interface between the substrate surface and the plasma polymer layer. Thus, in a preferred embodiment on polymer surfaces, a small amount of hydrogen is first added to the plasma process, so that the layer is crosslinked but not too much and can grow like a polymer on the polymer surface. In the case of metallic, ceramic or semiconducting surfaces, in a preferred embodiment, hydrogen is first added to the plasma gas atmosphere to ensure a high degree of crosslinking. Due to the reduction in stresses at the interface between the substrate and the fluorocarbon layer, the adhesion of the fluorocarbon layer to the surface is also improved. By continuously reducing the hydrogen gas flow rate in a preferred embodiment, the layer becomes more like a polymer and develops a higher fluorine content as the layer thickness increases. Therefore, the surface energy can also be reduced further. By omitting the addition of hydrogen at the end of the gradient plasma process, as provided in a preferred embodiment, surface energies resembling those of Teflon, i.e., in the range of 20 mN/m, can be achieved.

Another surprising advantage is the possibility of adjusting the surface energy. By varying the hydrogen gas flow, the surface energy can be controlled. Adding large quantities of hydrogen to the plasma gas atmosphere results in a lower fluorine content of the fluorocarbon polymer layer and thus a higher surface energy. A small amount of hydrogen in the plasma gas atmosphere produces a fluorocarbon layer having a low surface energy. Such a layer is like Teflon and has a surface energy of approximately 20 mN/m.

Thus, in an especially preferred embodiment, hydrogen may be added to a perfluorocycloalkane plasma, e.g., comprising perfluorocyclopropane or perfluorocyclobutane or perfluorocyclopentane, initially in an amount up to 9 cm³/min per liter, preferably 8.6 cm³/min per liter of reactor volume, preferably 0.3 to 9 cm³/min per liter of reactor volume, especially 0.29 to 8.6 cm³/min per liter of reactor volume. Then in a preferred embodiment, within a short period of time of 0.5 to 4 minutes, for example, especially within 2 minutes, the gas flow rate is regulated down to 0 cm³/min. While applying the gradient layer, the total pressure may be from 0.03 mbar to 2 mbar, especially 0.03 to 1 mbar. The power input per unit of electrode area is 0.007 W/cm² to 0.2 W/cm², especially 0.04 W/cm². The perfluorocycloalkane flow rate in this embodiment is preferably up to 15 cm³/min per liter of reactor volume, especially 0.5 to 15 cm³/min per liter of reactor volume.

The input power may be regulated down from up to 0.2 W/cm² to 0.007 W/cm² continuously and optionally, i.e., in a preferred embodiment.

In a preferred embodiment, the pressure is regulated at up to 1 mbar during the application of the gradient layer. A gradient layer with an increasing fluorine content but decreasing crosslinking of the layer and thus also decreasing layer hardness is advantageously formed on the substrate in this embodiment. In a preferred embodiment, the gradient may advantageously be up to 30 nm thick, especially 1 to 30 nm thick. However, other layer thicknesses are also possible.

Therefore, in an especially preferred embodiment, the invention relates to the application of a gradient layer, which is characterized by a gradient with regard to the fluorine content that extends over its entire thickness and by crosslinking of the layer. Thus, the present invention provides a so-called method according to which a gradient layer is applied to the substrate before applying the functional polymer layer and this is done by adding hydrogen in decreasing gas flow rates to the reactive gas containing the perfluorocycloalkane compounds.

The present invention may provide for the application of the functional polymer plasma layer of fluorocarbon compounds to be performed without a prior hydrogen and/or noble gas pretreatment and without prior application of a gradient layer. However, it is also possible to provide that according to the present invention, first a hydrogen and/or noble gas pretreatment of the substrate is performed and then a functional polymer layer is applied immediately or after performing the hydrogen and/or noble gas pretreament, first a gradient layer is applied and then the function polymer layer is produced.

The present also relates to substrates coated by the aforementioned method, comprising a substrate that has at least one of the fluorocarbon layers applied according to the preceding embodiment, especially in combination with a gradient layer.

Other advantageous embodiments are derived from the subclaims.

The present invention will now be described and explained on the basis of the following exemplary embodiments and the respective FIGS. 1 and 2.

### BRIEF DESCRIPTION OF THE DRAWINGS

FIG. 1 shows a coated substrate with a gradient layer and a function layer above it.

FIG. 2 shows a coated substrate with a functional layer without a gradient layer.

### EXAMPLES

### Example 1

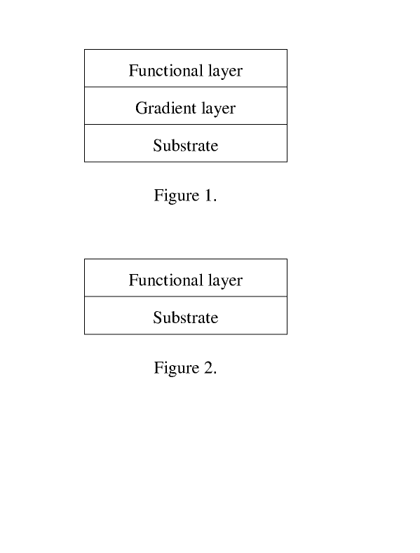

The coating system (reactor volume 3500 cm³) is first evacuated to a basic pressure of less than 0.02 mbar. Then argon is introduced for pretreatment, i.e., for cleaning and chemical activation, at a rate of 20 cm³/min. The total gas pressure here is regulated at 0.15 mbar. By applying a high-frequency voltage of 13.56 MHz a glow discharge is ignited between the two electrodes. The power input by this pretreatment plasma amounts to 150 W. After 10 minutes, the plasma is turned off and the system is evacuated again. Next, to generate the gradient layer, hydrogen (H) is introduced at the rate of 10 cm³/min and perfluorocyclobutane (C₄F₈) is introduced at the rate of 34 cm³/min. The total pressure is 0.150 mbar and the power input is 0.04 W/cm². The H flow rate is regulated down to 0 cm³/min within 30 seconds. The plasma then burns further continuously. Next the substrate (FIG. 1) is covered with a functional layer during the following plasma process phase. The C₄F₈ gas flow rate during this coating process continues to be 34 cm³/min (abs.) at a power input of 0.04 W/cm² and a gas pressure of 0.15 mbar. The plasma treatment time to produce the functional layer is 2 minutes.

### Example 2

After the pretreatment as described in Example 1, a fluorocarbon layer is deposited directly without a gradient in the plasma (FIG. 2).

All references cited and/or discussed in this specification are incorporated herein by reference in their entireties and to the same extent as if each reference was individually incorporated by reference.

1. A method for producing a thin film transistor comprising in the order recited, the steps of:
preparing a glass substrate;
providing a negative photosensitive coating comprised of a photosensitive material which has properties of a semiconductor on the glass substrate;
providing a transparent mold plate which has a plurality of opaque protrusions arranged in accordance with a predetermined pattern;
pressing the plurality of opaque protrusions of the transparent mold plate into the negative photosensitive coating of the glass substrate with closely controlled uniform pressure;
curing a part of the negative photosensitive coating which is adjacent to the opaque protrusions and has a shape corresponding to the pattern via a flash from a UV light; and
separating the transparent mold plate from the glass substrate;
cleaning the glass substrate after separating with a chemical solvent to remove uncured residual negative photosensitive coating which was shielded under the opaque protrusions; and
forming the thin film transistor after the negative photosensitive coating made from changeable material is pressed, cured, separated and cleaned.

2. The method for producing the thin film transistor as claimed in claim 1, wherein the negative photosensitive coating is provided using spin-coating.

3. The method for producing the thin film transistor as claimed in claim 1, wherein pressing the transparent mold plate with close control into the negative photosensitive coating of the glass substrate is performed to achieve a predetermined depth of penetration by the transparent mold plate.

4. (canceled)

5. The method for producing the thin film transistor as claimed in claim 1, wherein the transparent mold plate is comprised of one of a glass material or quartz and wherein the opaque protrusions are comprised of metallic materials.

6. The method for producing the thin film transistor as claimed in claim 5, further comprising providing and adhesion layer between the transparent mold plate and the opaque protrusions which has a coefficient of thermal expansion ranging between that of the transparent mold plate and that of the opaque protrusions.

7. The method for producing the thin film transistor as claimed in claim 6, wherein the adhesion layer is comprised of a metallic oxide of a predetermined metal.

8. The method for producing the thin film transistor as claimed in claim 7, wherein the predetermined metal one of Cr, Mo or W and wherein the metallic oxide is a transition-metal oxide corresponding to the predetermined metal.

9. The method for producing the thin film transistor as claimed in claim 5, further comprising arranging a dewetting layer, which is de-wetted from the negative photosensitive coating, onto the metallic material.

10. The method for producing the thin film transistor as claimed in claim 9, wherein the dewetting layer is comprised of Teflon.

11. The method for producing the thin film transistor as claimed in claim 1, further comprising providing an image sensor for aligning the transparent mold plate with the glass substrate.

12. The method for producing the thin film transistor as claimed in claim 11, wherein the image sensor is one of a charge coupled device (CCD) or complementary metal-oxide semiconductor (CMOS).

13. A thin film transistor made by the method claimed in claim 1.

14-27. (canceled)
